(19) United States
(12) Patent Application Publication
(10) Pub. No.: US 2011/0289764 A1
(43) Pub. Date: Dec. 1, 2011

(54) Method of Assembling A Hearing Aid

(75) Inventor: Salman Parsi, Somerset, NJ (US)

(73) Assignee: SIEMENS HEARING INSTRUMENTS, INC., Piscataway, NJ (US)

(21) Appl. No.: 12/786,689

(22) Filed: May 25, 2010

(51) Int. Cl. H04R 31/00

(52) U.S. Cl. 29/594

(57) ABSTRACT

A method (20) of assembling a hearing aid that uses a shell locator (35) to guide the relative placement of the shell (34) and the faceplate (32).

### FIELD OF INVENTION

The present invention relates to hearing aids. More particularly, the present invention relates to assembling a custom in-the-ear (ITE) hearing aid.

### BACKGROUND OF THE INVENTION

A conventional ITE hearing aid may comprise a housing or shell that defines a generally closed cavity therein in which are arranged a power source, an input transducer, for example, a microphone, and associated amplifier for transforming external sounds into electrical signals, a signal processor for processing the transformed signals and producing hearing-loss compensated electrical signals, and an output transducer, called a receiver, for transforming the processor signals into hearing-loss compensated sounds that are emitted into the ear. Some of the components are normally arranged on, and affixed to, a faceplate of the hearing aid, which is part of the housing/shell but is a separate part from the remainder of the housing/shell during the casing or assembly process. The faceplate is normally located on the portion of the hearing aid facing away from a hearing aid user's ear and may take on various configurations.

Typically, before its assembly, a hearing aid is first designed and modeled for its desired operating and physical characteristics. This is now mostly done using appropriate modeling software that, among other tasks, is used to select and virtually locate the components inside the cavity of the shell in a manner to avoid collisions with each other and with the shell. Such software will have stored therein, or access to, digitized forms and features of the various components for optimization of the hearing aid construction as well as a variety of other modeling tasks and operations. This information includes the unique configuration and performance data for the prospective user of the hearing aid. FIG. 1 shows exemplary computer screen shots of a hearing aid model rendered by a Siemens AutoMoDe detailing and modeling software application (FIG. 1(a) is an opaque perspective and FIG. 1(b) is a transparent perspective of the single hearing aid).

Thereafter, the hearing aid is constructed according to the modeling. As noted above, some of the components are normally affixed to the faceplate during this casing or assembly process. The shell and the faceplate are then attached to one another in a desired position so that all of the components will fit into the cavity of the shell as modeled. Often, the assembly steps are largely done manually, although many if not all may be automated in some fashion. Also, it is now common practice that a variety of faceplates with pre-assembled components are available for selection, depending upon the overall modeling of the hearing aid (although some components may still be added to the faceplate).

The various components generally do not have pre-defined positions inside the cavity of the shell. There are several factors that determine the positioning of the components, such as, the shape and configuration of a person's ear, the type of hearing aid being constructed; and the performance of the hearing aid. Further, despite the modeling, problems can still arise in the positioning of the components and the alignment of the faceplate and the shell, especially if manually performed. Such problems include creating feedback conditions for the hearing aid, causing damage to components, and introducing time delays and higher costs in producing the hearing aid. U.S. Patent Publication US 2009/0196447 by McBagonluri, et al., published on Aug. 6, 2009, assigned to the owner of the present application and which is hereby incorporated by reference herein, describes hearing aid assembly methods to address these concerns.

It would be advantageous to have the shell to faceplate attachment to be definitively guided in some way to position the parts exactly as modeled. This would, among other things, overcome problems, like feedback, arising from current hearing aid configurations and assembly methods.

### SUMMARY OF THE INVENTION

The present invention obviates the aforementioned problems by providing a method for assembling a hearing aid having a shell with a faceplate and operational components located within the shell, comprising: modeling operational and physical characteristics of the hearing aid; producing a shell, faceplate, and operational components according to the modeling; positioning and affixing a first group of components to the shell and a second group of components onto the faceplate according to the modeling; positioning and affixing a shell locator onto the faceplate according to the modeling; positioning the shell onto the faceplate so that the shell and the shell locator form tessellating and interlocking mated parts, said shell locator guiding the shell to enclose the second group of components according to the modeling; and affixing the shell with the faceplate so that the operational components are contained within the shell.

The modeling may comprise utilizing detailing and modeling software to select and virtually locate the components inside the cavity of the shell in a manner to avoid collisions with each other and with the shell. The producing may comprise producing at least one of the shell, the faceplate, an operational component, and the shell locator by an additive manufacturing method. In such case, the additive manufacturing method may be rapid prototyping using stereolithography.

Further, the positioning and affixing a shell locator step may comprise fixedly engaging the shell locator onto the faceplate via protruding loops formed on the shell locator hooked over posts formed on the faceplate. The loop-post combinations may be arranged to fixedly hold the shell locator in a definite location on the faceplate. Alternatively, the positioning and affixing a shell locator step may comprise affixing the shell locator in a pre-determined location on the faceplate to enable the positioning of the shell on the faceplate according to the modeling.

Further, the method may also comprise shaping the joined shell and faceplate in order to produce a uniform shell shape for the hearing aid according to the modeling. The shaping may comprise removing the shell locator and excess faceplate material. Alternatively, the shaping may comprise conducting a computerized faceplate cut implemented by grinder apparatus that is controlled by visual modeling and design software.

The present invention may also provide a method of assembling a hearing aid having a shell, a faceplate and operational components which have been modeled to achieve collision-free positioning, comprising providing a shell and a faceplate with respective operational components according to the modeling; positioning and affixing a shell locator onto the faceplate, said shell locator and the shell forming interlocking mated parts; positioning the shell onto the faceplate, said shell locator guiding the shell to enclose the components according to the modeling; and affixing the shell with the faceplate.

The positioning and affixing a shell locator step may comprise affixing the shell locator in a pre-determined location on the faceplate to enable the positioning of the shell on the faceplate. Also, the method may comprise shaping the joined shell and faceplate in order to produce a uniform shell shape for the hearing aid. The shaping step may comprise removing the shell locator and excess faceplate material.

The present invention may also provide an apparatus for assembling a hearing aid having a shell, a faceplate and operational components which have been modeled to achieve collision-free positioning, comprising a shell locator plate that is affixable to the faceplate and adapted to snugly fit the contours of the shell positioned on the faceplate, said plate guiding and fixing the position of the shell onto the faceplate to enclose the components according to the modeling. The plate may form an interlocking mated part with the shell. Also, the plate may be removable during the shaping of the joined shell and faceplate to produce a uniform shell shape for the hearing aid.

### BRIEF DESCRIPTION OF THE DRAWINGS

For a better understanding of the present invention, reference is made to the following description of an exemplary embodiment thereof, and to the accompanying drawings, wherein:

FIG. 1 are two computer screen shots of a hearing aid model from a modeling software application (one is an opaque perspective and the other is a transparent perspective of the single hearing aid);

FIG. 2 is a flow chart of a method for assembling a hearing aid in accordance with the present invention;

FIG. 3 are computer renderings of angled views of components used in the method of FIG. 2;

FIG. 4 are rotated views of the computer renderings of FIG. 3; and

FIG. 5 are side views of a hearing aid assembled with the method of FIG. 2.

### DETAILED DESCRIPTION

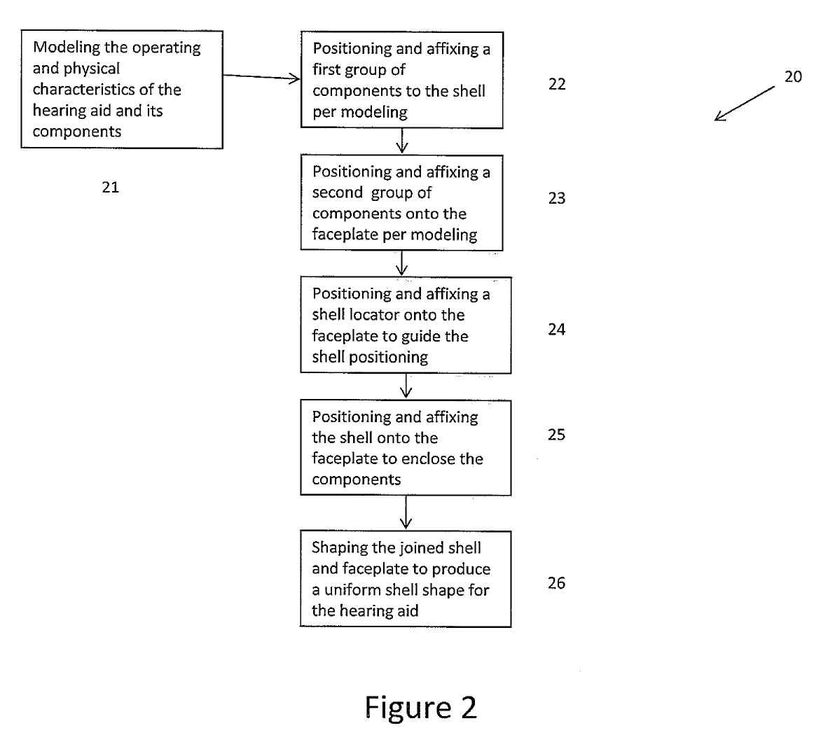

FIG. 2 shows an exemplary method 20 for assembling a hearing aid in accordance with the present invention. First, a hearing aid is modeled (i.e., designed and modeled) for its desired operating and physical characteristics (step 21). This may be mostly done using appropriate modeling software that, among other tasks, is used to select and virtually locate the components inside the cavity of the shell in a manner to avoid collisions with each other and with the shell. Such software will have stored therein, or access to, digitized forms and features of the various components for the optimization of the hearing aid construction as well as a variety of other modeling tasks and operations. This information includes the unique configuration and performance data for the prospective user of the hearing aid. It is common practice to first select and locate the components that will be positioned and affixed to the shell, like the receiver, and then select and locate the components that will be positioned on and affixed to the faceplate, like the microphone. The order may be reversed and, as noted above, the faceplate may be selected from a number of available configurations and functionalities utilizing pre-assembled components. The shell and the faceplate are also positioned with respect to one another and known collision detection algorithms are used to ensure that the various components do not collide with one another. Upon completion of this step, a virtually-modeled hearing aid and components is obtained.

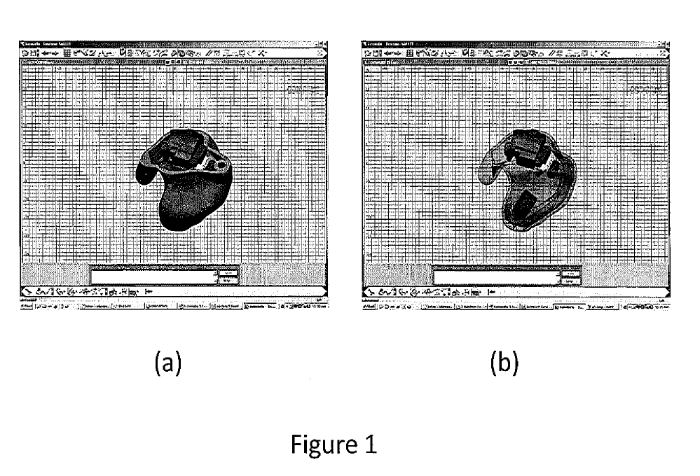

The results of the modeling, including intermediate and final perspectives of the components and/or the entire hearing aid, are typically displayed as digital 3D representations. FIG. 1 shows two examples. As noted above, Siemens AutoMoDe detailing and modeling software application may be used for this purpose although other 3D modeling software may also be used.

Next, the hearing aid is constructed according to the modeling. If virtually-modeled, the physical hearing aid components may be constructed using any industry-known technique for transforming a virtual 3D model into a physical object, for example, an additive manufacturing method, such as rapid prototyping using stereolithography (SL). Alternatively, and whether or not virtually-modeled, the physical discrete components may be manufactured and/or obtained for assembly via industry-known manners. Some of the hearing aid components, like the receiver, are positioned and affixed within the shell (step 22). Other components, like the microphone, are positioned and affixed onto a faceplate for the hearing aid (step 23) or a faceplate with pre-assembled components is selected. The positioning and affixing of the various components is done in accordance with the modeling and the affixing can be done in any industry-known manner. The order of the positioning and affixing may follow industry or proprietary practices.

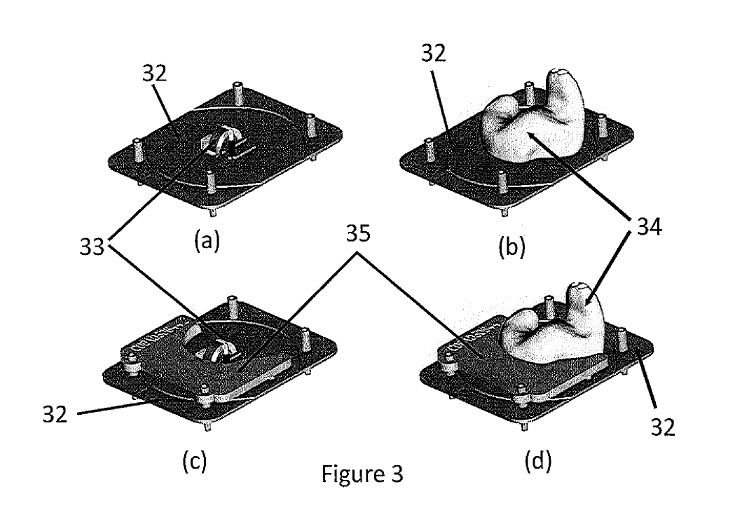

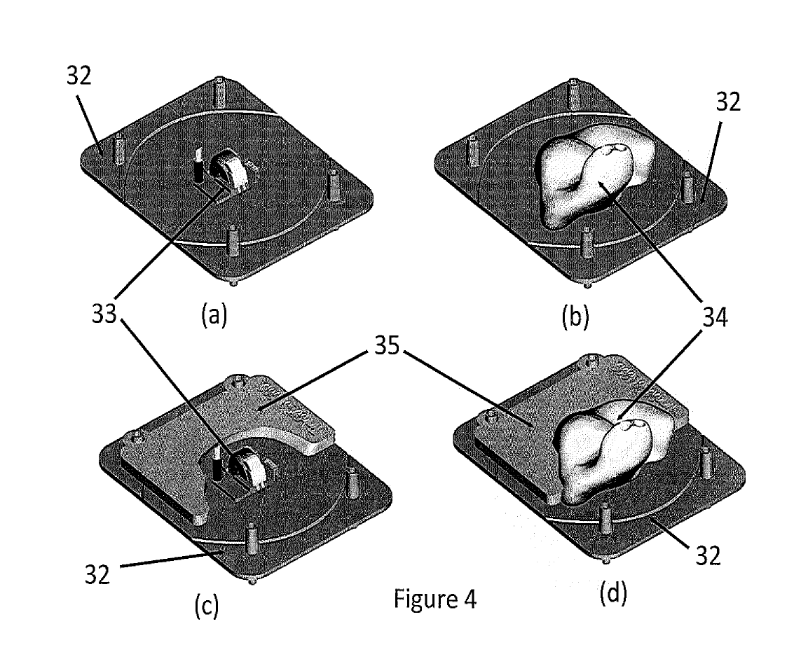

The faceplate is part of the housing/shell but is a separate part from the remainder of the housing/shell during this assembly process. Notably, at this stage, the faceplate is sized and shaped somewhat differently (but usually larger) than the faceplate that is finally bonded on the fully-assembled hearing aid. This is to accommodate different types of hearing aids to be constructed and the types of components that may need to be affixed to the faceplate. The faceplate is normally located on the portion of the hearing aid facing away from a hearing aid user's ear. FIG. 3(a) shows an exemplary faceplate 32 with hearing aid components 33 affixed thereon. FIG. 3(b) shows an exemplary shell 34 positioned on the faceplate 32 overlying the components (hidden). FIGS. 4(a) and 4(b) show rotated views.

A shell locator is then affixed onto the faceplate 32 (step 24). The shell locator is a tool used to position the shell 34 onto the faceplate 32 exactly as it was modeled. FIG. 3(c) shows a shell locator 35 fixedly engaged onto the faceplate 32 via protruding loops hooked over posts formed on the faceplate 32. FIG. 4(c) shows a rotated view. The loop-post combinations are arranged to fixedly hold the shell locator 35 in a definite location on the faceplate 32. Alternatively, the shell locator 35 may be affixed onto the faceplate 32 in a manner similar to that as the other components 33 or any other industry-known manner. The shell locator 35 is affixed in a pre-determined location on the faceplate 32 to enable the positioning of the shell 34 on the faceplate 32 according to the modeling.

The shell locator 35 may be produced with the shell 34, for example, via an additive manufacturing method, such as rapid prototyping using stereolithography (SL), or any other industry-known manner. It is shaped and sized so that the shell locator 35 forms a tessellating and interlocking mated part with a portion of the perimeter of the shell 34 opening that will be affixed with the faceplate 32. Further, it is shaped and sized so that shell locator 35 will position the shell 34 onto the faceplate 32, and will enable the shell 34 to enclose the hearing aid components 33, exactly as it was modeled. FIG. 3(d) shows an exemplary mating of the shell locator 35 with the shell 34 on the faceplate 32. The shell 34 overlies the hearing aid components 33 (hidden). FIG. 4(d) shows a rotated view.

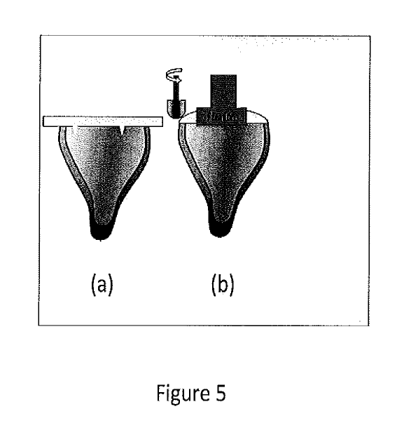

The shell 34 and the faceplate 32 are positioned and then affixed to one another (step 25). The shell locator 35 exactly guides the shell 34 to the desired position on the faceplate 32 so that the components 33 will fit into the cavity of the shell 34 as modeled. It is understood that the precision of the positioning will be subject to imperfections in the various components, particularly the shell locator 35, the shell 34, and the tessellation and interlocking therebetween. The shell 34 and the faceplate 32 are attached to one another in a manner similar to that as the other components 33 or any other industry-known manner. FIG. 5(a) shows a side view of the joined shell 34 and faceplate 32.

To finalize the assembly of the hearing aid, an industry standard technique can be used to shape the joined shell 34 and faceplate 32 (including, for example, removing excess faceplate 32 material) in order to produce a uniform shell shape for the hearing aid according to the modeling (step 26). As part of the shaping of the faceplate 32, the shell locator 35 will be removed along with the excess faceplate 32 material. The technique can be, for example, a computerized faceplate cut implemented by grinder apparatus that is controlled by visual modeling and design software, like CAD/RSM (Rational Software Modeler) software. In such case, a battery door opening can be used to provide fixation during the cut. FIG. 5(b) shows a side view of the joined shell 34 and faceplate 32 of FIG. 5(a) with the excess faceplate 32 cut away by a grinder 51.

Other modifications are possible within the scope of the invention. For example, although the steps of each method have been described in a specific sequence, the order of the steps may be re-ordered in part or in whole. Further, the described methods, or any of their steps or portions of their steps, may be carried out automatically by appropriate instrumentation and tools or with some or minimal manual intervention.

What is claimed is:

1. A method for assembling a hearing aid having a shell with a faceplate and operational components located within the shell, comprising:
modeling operational and physical characteristics of the hearing aid;
producing a shell, faceplate, and operational components according to the modeling;
positioning and affixing a first group of components to the shell and a second group of components onto the faceplate according to the modeling;
positioning and affixing a shell locator onto the faceplate according to the modeling;
positioning the shell onto the faceplate so that the shell and the shell locator form tessellating and interlocking mated parts, said shell locator guiding the shell to enclose the second group of components according to the modeling; and
affixing the shell with the faceplate so that the operational components are contained within the shell.

2. The method of claim 1, wherein the modeling comprises utilizing detailing and modeling software to select and virtually locate the components inside the cavity of the shell in a manner to avoid collisions with each other and with the shell.

3. The method of claim 1, wherein the producing comprises producing at least one of the shell, the faceplate, an operational component, and the shell locator by an additive manufacturing method.

4. The method of claim 3, wherein the additive manufacturing method is rapid prototyping using stereolithography.

5. The method of claim 1, wherein the positioning and affixing a shell locator comprises fixedly engaging the shell locator onto the faceplate via protruding loops formed on the shell locator hooked over posts formed on the faceplate.

6. The method of claim 5, wherein the loop-post combinations are arranged to fixedly hold the shell locator in a definite location on the faceplate.

7. The method of claim 1, wherein the positioning and affixing a shell locator comprises affixing the shell locator in a pre-determined location on the faceplate to enable the positioning of the shell on the faceplate according to the modeling.

8. The method of claim 1, further comprising shaping the joined shell and faceplate in order to produce a uniform shell shape for the hearing aid according to the modeling.

9. The method of claim 8, wherein the shaping comprises removing the shell locator and excess faceplate material.

10. The method of claim 8, wherein the shaping comprises conducting a computerized faceplate cut implemented by grinder apparatus that is controlled by visual modeling and design software.

11. A method of assembling a hearing aid having a shell, a faceplate and operational components which have been modeled to achieve collision-free positioning, comprising:
providing a shell and a faceplate with respective operational components according to the modeling;
positioning and affixing a shell locator onto the faceplate, said shell locator and the shell forming interlocking mated parts;
positioning the shell onto the faceplate, said shell locator guiding the shell to enclose the components according to the modeling; and
affixing the shell with the faceplate.

12. The method of claim 11, wherein the positioning and affixing a shell locator comprises affixing the shell locator in a pre-determined location on the faceplate to enable the positioning of the shell on the faceplate.

13. The method of claim 11, further comprising shaping the joined shell and faceplate in order to produce a uniform shell shape for the hearing aid.

14. The method of claim 13, wherein the shaping comprises removing the shell locator and excess faceplate material.

15. An apparatus for assembling a hearing aid having a shell, a faceplate and operational components which have been modeled to achieve collision-free positioning, comprising a shell locator plate that is affixable to the faceplate and adapted to snugly fit the contours of the shell positioned on the faceplate, said plate guiding and fixing the position of the shell onto the faceplate to enclose the components according to the modeling.

16. The apparatus of claim 15, wherein the plate forms an interlocking mated part with the shell.

17. The apparatus of claim 15, wherein the plate is removable during the shaping of the joined shell and faceplate to produce a uniform shell shape for the hearing aid.
